(19) United States
(12) Patent Application Publication
(10) Pub. No.: US 2013/0254294 A1
(43) Pub. Date: Sep. 26, 2013

(54) Method and Arrangement For Ranking Users

(71) Applicant: Lennart Isaksson, Karlskrona (SE)

(72) Inventor: Lennart Isaksson, Karlskrona (SE)

(73) Assignee: Telefonaktiebolaget L M Ericsson (publ), Stockholm (SE)

(21) Appl. No.: 13/991,443

(22) PCT Filed: Feb. 4, 2011
(86) PCT No.: PCT/SE2011/050129

§ 371 Date: Jun. 4, 2013

(30) Foreign Application Priority Data
Dec. 9, 2010 (IN) 2941/DEL/2010

(51) Int. Cl. H04L 29/08

(52) U.S. Cl. CPC H04L 67/00
USPC 709/204

(57) ABSTRACT

A method and arrangement for providing information on a social rank of a first user (A) within a plurality of users (302) in a telecommunication network. A data receiver (300a) in a ranking manager (300) receives transaction data referring to communication events involving said users, and identifies a cluster of socially related users with the first user, based on the transaction data. A data analyzer (300b) in the ranking manager (300) determines relation metrics for the users in the cluster based on the transaction data. The relation metrics indicate an extent of aggregated outgoing events of the users in the cluster. A ranking calculator (300c) in the ranking manager (300) then calculates the social rank of the first user in multiple iterations based on relation metrics of aggregated outgoing events from the first user, and further based on social ranks calculated in a preceding iteration for other users in the cluster, until the social rank of the first user is stabilized. The resulting social rank of the first user can then be provided to one or more service providers (310).

### TECHNICAL FIELD

The invention relates generally to a method and arrangement for providing a social ranking of a terminal user in a telecommunication network in terms of a social network, which may be utilized for selecting or creating relevant services for that user or for other socially related users.

### BACKGROUND

In the field of telecommunication, solutions have been devised for identifying and offering services and products that are particularly relevant and attractive to different terminal users according to their interests and needs in different situations, also referred to as targeted marketing. It is therefore of great interest for service providers to understand their customers' behavior when communicating, in order to achieve great efficiency in their marketing activities and service offerings. Thereby, the users will also be better served by receiving more relevant and interesting service and product offerings and not receiving irrelevant ones, which could increase their general responsiveness to such offerings. In this description, the term “user” refers to any user of a terminal in a telecommunication network, e.g. a subscriber, being a potential service consumer.

There are also solutions for analyzing users in a telecommunication network and identifying segments of users, also referred to as “clusters”, having common characteristics in some sense, e.g. to provide service offerings to users in a specific segment jointly. This analysis work is typically based on traffic data generated by communication nodes in the network which is stored as Call Detail Records (CDR) in a Charging data Reporting System (CRS) or the like, mainly to determine accurate charging of customers for executed calls and sessions.

The traffic data or CDRs may refer to various communication sessions such as voice calls, SMS (Short Message Service), MMS (Multimedia Message Service), downloadings, e-mails, web games, etc., in this description collectively referred to as “events”. Typically, events of the above types occur when users communicate with each other, but also when users communicate with their network operator, e.g. when refilling a pre-paid account, adjusting of account or subscription, and so forth, which also could be noteworthy events reflecting the users' behavior. The traffic data includes information on the sessions, such as type of service, duration, time of day and location. This kind of information can thus be used to analyze the customers' behavioral characteristics in terms of service usage, a process also referred to as “data mining”. For example, Machine Learning Algorithms (MLA:s) and tools can be used for processing the traffic data to extract information therefrom.

A Data Mining Engine (DME) may further be employed for processing the traffic data using various techniques for data mining and MLA:s. FIG. 1 illustrates an example of how data mining can be employed for a telecommunication network to enable relevant and adapted services, according to the prior art. A DME 100 typically uses one or more MLA:s 100a for processing traffic data TD provided from a data source 102, and further to identify customers segments and clusters. CDR information from the network is collected in the data source 102 which is then provided as traffic data TD to the DME 100. After processing the traffic data, the DME 100 provides the resulting segment information as output data to various service providers 104 to enable adapted services and targeted marketing activities.

Another technology for analyzing users refers to social networks and determination of a rank of the users in terms of a social network based on executed communications, in this description called the “social rank”. For example, if a particular user is ranked relatively high in a group of socially related users, it can be assumed that the highly ranked user and his/her service usage will be relatively influential to other users in the group, and it is therefore likely that services consumed by that user can be potentially attractive to the other users as well. Thereby, information on the rank of one user of interest can be useful for selecting or creating relevant services for other users socially related to that user.

WO2010/043241 A1 discloses an example of determining a “user rank” for users in a telecommunication network from the number of relations with other users, based on their executed communications as derived from traffic data. Here, a user having many relations is given a relatively high rank. Further, a method of calculating a so-called “PageRank” is also known in the context of determining the popularity or significance of web pages. This method basically provides a high PageRank for web pages which are referenced to by other web pages, i.e. all incoming references to a web page of interest from other web pages contribute to increase the rank of the web page of interest.

However, no efficient procedure or method is known which can provide a sufficiently truthful ranking of terminal users in terms of a social network to estimate their influence on each other, e.g. for use when creating and offering services. Applying the PageRank calculation method to terminal users in a telecommunication network would provide higher ranking of users receiving many calls as compared to the users making the calls, which is rather misleading, e.g. resulting in an unduly high social rank for a call center or the like that receives calls exclusively. It is also a problem that the total number of more or less socially related users in a telecommunication network is typically huge, often in the range of many thousands and even millions, thus making calculation of individual user ranks quite complicated and resource-demanding. For example, a cluster of socially related users which are linked to each other by having executed sessions, implying a great number of direct and indirect social relations, may be quite large.

### SUMMARY

It is an object of the invention to address at least some of the problems and issues outlined above. It is also an object to provide a mechanism for improved ranking of users in a communication network in terms of a social network. It is possible to achieve these objects and others by using a method and an arrangement as defined in the attached independent claims.

According to one aspect, a method is defined for providing information on a social rank of a first user within a plurality of users in a telecommunication network, which may be implemented in a functional unit or node that can be referred to as a ranking manager. In this method, the ranking manager receives collected transaction data referring to communication events involving the users. The ranking manager then identifies a cluster of socially related users, including the first user, from the users based on the collected transaction data, wherein any two users in the cluster are deemed to be socially related when exceeding a predefined minimum communication event threshold. Relation metrics are further determined for the users in the cluster based on the collected transaction data, which relation metrics indicate an extent of aggregated outgoing communication events between the users in the cluster.

The ranking manager then calculates the social rank of the first user in multiple successive iterations such that the social rank of the first user is calculated in each iteration based on relation metrics of aggregated outgoing communication events from the first user, and further based on social ranks calculated in a preceding iteration for other users in the cluster being subjected to the outgoing communication events, until the social rank of the first user is deemed to be stabilized or converged. The calculated social rank of the first user can then be provided to one or more service providers or the equivalent.

According to another aspect, an arrangement is defined in a ranking manager that is configured to provide information on a social rank of a first terminal user within a plurality of terminal users in a telecommunication network. According to this arrangement, the ranking manager comprises a data receiver adapted to receive collected transaction data referring to communication events involving the users. The ranking manager also comprises a data analyzer adapted to identify a cluster of socially related users, including the first user, from the users based on the collected transaction data, wherein any two users in the cluster are deemed to be socially related when exceeding a predefined minimum communication event threshold. The data analyzer is further adapted to determine relation metrics for the users in the cluster based on the collected transaction data, the relation metrics indicating an extent of aggregated outgoing communication events between the users in the cluster.

The ranking manager also comprises a ranking calculator adapted to calculate the social rank of the first user in multiple successive iterations by calculating the social rank of the first user in each iteration based on relation metrics of aggregated outgoing communication events from the first user, and further based on social ranks calculated in a preceding iteration for other users in the cluster being subjected to the outgoing communication events, until the social rank of the first user is deemed to be stabilized or converged. The ranking calculator is further adapted to basically provide the calculated social rank of the first user to one or more service providers, e.g. by means of a suitable communication mechanism and interface.

The above method and arrangement may be configured and implemented according to different embodiments. In some possible embodiments, the relation metrics refer to any of: indications of whether the users have communicated, aggregated session duration, number of sessions, and aggregated charged amount. In further optional embodiments, the relation metrics may be reduced by a weighting factor referring to any of: a social distance between the first user and the other users, whether the events are outgoing or incoming relative the first user, and a recency of the communication events from the first user to the other users. The collected data may be obtained from Call Detail Records (CDRs) and may refer to any of: session duration, number of sessions, charged amount.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which:

FIG. 1 is a block diagram illustrating a conventional procedure for processing traffic data, according to the prior art.

FIG. 2 is an exemplary illustrative social network graph which may be applicable for this invention.

FIG. 3 is a block diagram illustrating a schematic processing flow when providing information on a social rank by means of a ranking manager, according to further example embodiments.

FIGS. 4a and 4b illustrate a simplified example of communication events between three users A-C.

FIG. 5 is a flow chart with actions that can be performed by a ranking manager, according to another example embodiment.

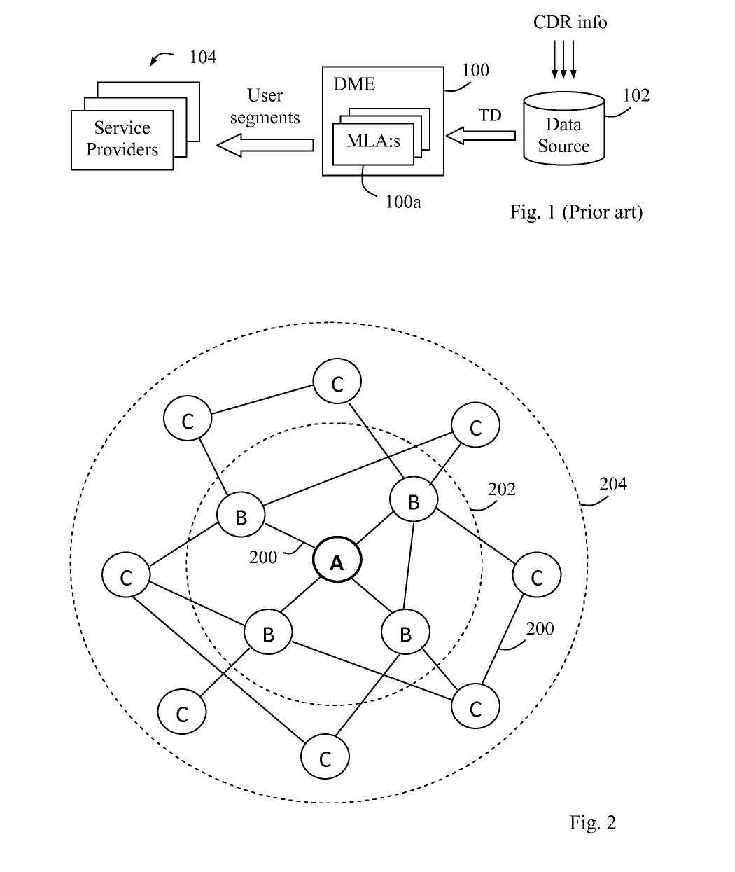

### DETAILED DESCRIPTION

Briefly described, the invention provides an automated and effective mechanism for obtaining useful information on the social rank of a particular terminal user of interest within a plurality of terminal users in a telecommunication network. The user of interest will be referred to as a “first user” in the following. The social rank of the first user is calculated based on collected traffic and transaction data reflecting the service usage of the users from which information on social relations between users can be derived.

The collected transaction data is used for identifying a cluster of socially related users, including the first user, from the users in the network. In order to perform the rank calculation, relation metrics indicating at least an extent or quantity of aggregated outgoing communication events that have occurred between the first user and the other users in the cluster, are determined based on the collected transaction data. The relation metrics may further indicate incoming events, i.e. calls made to the first user, and also events between the first user and a “system”, e.g. a network operator, such as when the user contacts an operator center or the like to renew or modify his/her subscription or to refill a prepaid account, and so forth, which may serve as an indicator of the first user's behavior as a subscriber or customer. The relation metrics are then used as input to a rank calculation formula and the social rank of the first user is calculated multiple times in an iterative manner, until the resulting rank becomes stabilized. This calculation is made further based on social ranks calculated in a preceding iteration for other users in the cluster being subjected to said outgoing communication events.

To support the analysis of a social network with terminal users, network graphs can be created with nodes representative of the users and edges between the nodes representative of social relationships between the users implied by occurred communication events, i.e. sessions executed by the users in the nodes. Each edge thus corresponds to one or more events, preferably exceeding a minimum threshold to validate or qualify the event as indicating a social relation, e.g. a duration of more than 10 seconds for voice calls to eliminate any wrong number calls, or a minimum number of call events to eliminate any one-time inquiries.

An edge connecting two nodes may be represented by a metric value in both directions suitable for quantifying the communication relationships, e.g. by a certain “dimension” selected to reflect usage of services such as the total call duration or the number of calls made between the two nodes. Thus, a high metric value of an edge indicates a strong social relation, and vice versa. An edge can also have a single direction, e.g. when one user always calls another user but never, or very seldom, the other way round, or two opposite directions when events are accounted for both ways, depending on the implementation.

The metric value of an edge between two nodes thus reflects the sum of events occurring between the corresponding two users which may be determined in any suitable manner to reflect the social relation, and the invention is not limited in this respect. For example, a call event of 50 minutes duration when user A calls user B may be credited to both users for having conducted a relatively long conversation. The call is thus credited by 100% to A (as outgoing call) and 100% to B (as incoming call), thus resulting in 50 minutes to both A and B which duration is added to their respective relation metrics. In another example, e.g. a call event of much shorter duration, the event may be credited exclusively to the calling user A (100%) for having made the call.

It can be assumed that the calling user has some kind of influence on the called user by specifically taking outgoing communication events into account when calculating the rank of a user. When determining the relation metrics for a certain user of interest, the metric of each event may be multiplied by a weighting factor that may be greater for outgoing events than incoming events. In a simplified example, the weighting factor for incoming events may be set to zero, thus neglecting the incoming events when calculating the rank.

This type of graph can be created for individual users as derived from collected information on executed communication sessions between the users, e.g. based on CDR information. An exemplary network graph for a particular user of interest “A” is illustrated in FIG. 2 with nodes A-C and edges 200 between the nodes, A being the central node under consideration representing a first user in a social network.

In order to support the determination of the rank of the first user in the social network, the network graph in FIG. 2 depicts a cluster of socially related users, including the first user, and the cluster has been identified with a certain number of neighbor levels around the node of the first user according to a predefined distance criterion. For example, users more than two levels away from the first user under consideration may be deemed to have a negligible influence on that user, thereby limiting the cluster and the graph to two neighbor levels, as in the example shown in FIG. 2.

This graph thus shows that the first user A has made sessions with a number of other users B, the latter thus being direct communication partners or neighbors with A, indicating a direct social relation between user A and each one of users B. The users B are in turn direct communication partners or neighbors with further users C, thus making users C indirect neighbors with the first user A indicating an indirect social relation between user A and each one of users C. A network graph of a social cluster is typically restricted to a certain number of levels of neighborship, as dictated by the distance criterion, and the network graph depicted in FIG. 2 has a depth of two neighbor levels 200 and 202.

The number of neighbor levels selected for a user of interest to create a social graph is referred to as the “range” of the graph, and the minimum number of edges between two users, i.e. the shortest path between their respective nodes in the graph, is referred to as the social “distance” between the two users. Although the following examples and embodiments refer to just one level of neighbors directly linked to the first user of interest, the invention can be applied also for clusters with any number of levels including indirectly linked neighbors according to a predefined distance criterion. Further, an event matrix may be formed with relation metrics between different users in the cluster, i.e. the matrix contains one aggregated metric for each edge/relation in either direction, which will be described in more detail later below.

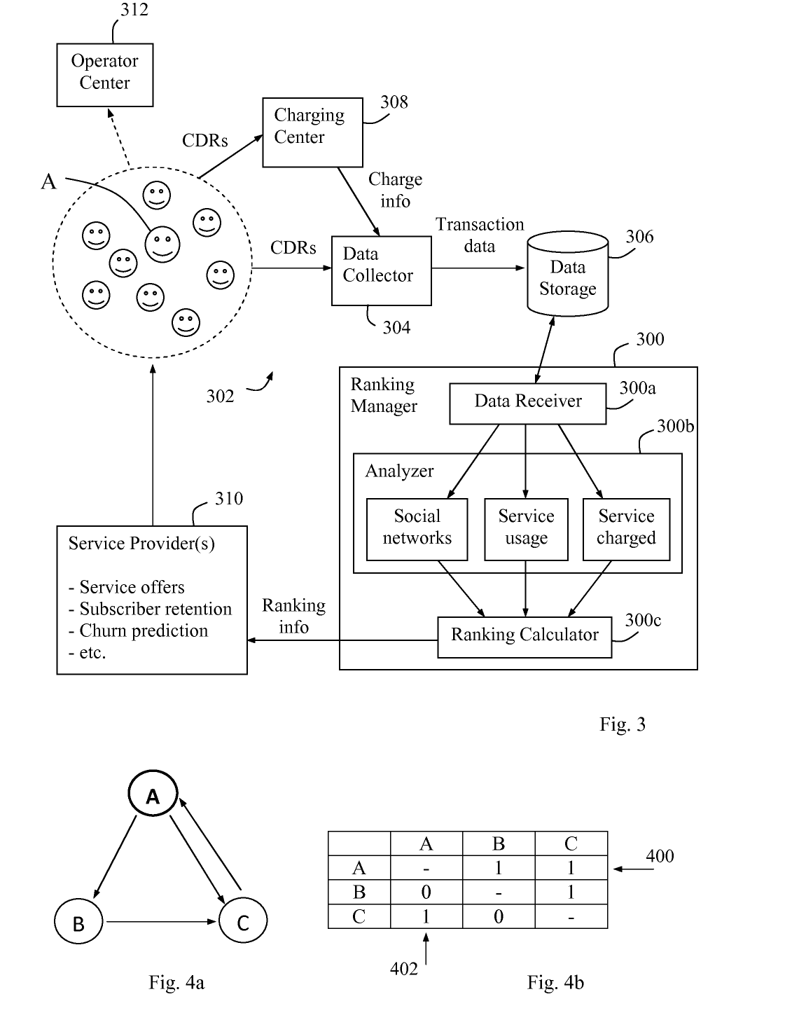

The invention can be realized by implementing various processing and computing functions in an entity or server which will be referred to in the following as a “ranking manager”, although any other suitable term could be applied such as, e.g., a unit/manager/module/entity for “grading” or “classification” of users, and so forth. An example procedure of determining user ranks will now be described with reference to FIG. 3, illustrating schematically an overall process executed by the shown ranking manager 300.

The input data needed and used by the ranking manager 300 to determine effective and truthful ranks of users includes traffic and transaction data reflecting the service usage of the users from which information on social relations between users can be derived. As described above, data of executed service sessions can be extracted from CDR information, in this description referred to as “transaction data”, which may be aggregated into “usage data” and “social data”, respectively. For example, the usage data may be data aggregated in a specific “dimension” selected to reflect the usage of services, as mentioned above, such as call time, spendings, number of calls, etc. This usage data is basically combined with user relations derived from the social data, to define the social network, e.g. in the manner of a social graph as described above. Typically, the amount of available input data will be quite large, e.g. for applications in a system for telecommunication services.

In FIG. 3, a social rank is to be determined for a first user denoted “A” within a plurality of users 302 in a telecommunication network, e.g. a mobile network. As sessions are executed amongst the users 302, such as voice calls, SMS, MMS, downloadings, e-mails, web games, etc., CDRs are generated in the network which are collected by a data collector 304. Sessions may also be executed between users and an operator center 312 or the like, e.g. for establishing, adjusting or finishing subscriptions or subscription terms, or for refilling a prepaid account, and so forth. These sessions between user and “system” may be considered in addition to sessions between users when determining the rank of a user. For example, it may be interesting to know whether a user refills his/her prepaid account or not before making a call, or if he/she refills the account well before zero is reached, or tends to select very cheap subscriber terms, and so forth.

The CDRs are also received in a charging center 308 which handles charging of subscribers for services in the network based on the CDRs. The charging center 308 also provides charge information to the data collector 304, which then derives transaction data from the received CDRs and charge information, and the transaction data is collected and stored in a suitable data storage 306.

It is assumed that the collection of transaction data in storage 306 is made on a more or less continuous basis such that the data therein is kept up-to-date. The transaction data may also have a time stamp that can be considered when calculating the social rank such that older data is given less impact on the rank than more recent data, which will be described in more detail later below. The data may be given an expiry time after which it is discarded from the storage 306 as not being relevant any more.

When the social rank is to be determined for the first user A, a data receiver 300a in the ranking manager 300 receives the transaction data collected in storage 306 which thus refers to communication events that have occurred amongst the users 302. The received transaction data is then analyzed by an analyzer 300b in the ranking manager 300. In particular, the analyzer 300b identifies a cluster (or social network) of socially related users, including the first user A, from said plurality of users 302 based on the collected transaction data, in the figure schematically indicated as “social networks”. The cluster may be defined such that any two users in the cluster are deemed to be socially related when exceeding a predefined minimum communication event threshold, and such that a preset social distance from the first user is not exceeded, i.e. the cluster has a limited number of neighbor levels around the first user according to a predefined distance criterion. An example of such a cluster may be defined in the manner of the social graph in FIG. 2.

The analyzer 300b further determines relation metrics for the users 302 in the cluster based on the transaction data from data receiver 300a, where the relation metrics basically indicate the extent or amount of aggregated outgoing communication events between the users in the cluster, that is, how much the users have communicated with each other. The relation metrics may be determined from usage data aggregated in a specific “dimension” reflecting the usage of services, e.g. the total call time or the number of calls, as mentioned above, or the amount of spendings for executing the events, in the figure schematically indicated as “service usage” and “service charged”, respectively.

In this solution, relation metrics are determined for the first user A relative the other users 302 in the cluster chiefly based on aggregated outgoing communication events from the first user to the other users. Depending on the implementation, the relation metrics for the first user relative the other users may be determined also based on aggregated incoming communication events from the other users to the first user, e.g. multiplied by a weighting factor which is smaller for incoming events than for the outgoing ones. This solution may thus put more weight on outgoing sessions and calls made from the first user, when determining the social rank of that user in the social network or cluster, assuming that the calling user has greater influence than the called user. However, the weighting factor for outgoing and incoming calls may for example be dependent on the call duration. Some examples of weighting a metric value for outgoing and incoming events by different percentages when determining the relation metrics, were presented above.

It should be noted that in practice, a relation metric for the first user A relative another user B in the cluster may be determined as the sum or aggregation of multiple events having occurred between the two users A and B over time. In that case, the relation metrics may be determined with greater accuracy or relevance if events that have occurred relatively long ago are given less weight than more recent events. Therefore, the relation metric for A to B can be reduced by a weighting factor referring to a “recency” of the events between the first user and the other users. The recency factor is proportional to the time since the event took place, e.g. measured in number of days, by decreasing the recency factor with increased time finally becoming zero when the event is deemed “out-of-date”.

Furthermore, the weighting factor may also refer to a social distance between the first user and the other users, such that events with a direct neighbor is given more weight than events with indirect neighbor when determining the relation metric. In a simplified example, only direct neighbors to the first user A are taken into account when determining the social rank of A, i.e. limiting the cluster to only one neighbor level such as the level 202 with neighbors B shown in FIG. 2.

A simplified example is illustrated in FIG. 4a where a cluster of users A, B and C are identified as being socially related to each other by having made calls as indicated by arrows. In this example, user A has made one call to user B and one call to user C, while user B has made one call to user C and user C has made one call to user A. An exemplary and rudimentary way of determining relation metrics from these events is to give each event a value of 1 regardless of duration, as illustrated in an event matrix shown in FIG. 4b. In this matrix, outgoing calls from A are presented in the row 400 of A, while incoming calls to A are presented in the column 402 of A.

Returning to FIG. 3, the analyzer 300b provides information on the identified cluster of socially related users and the determined relation metrics for each relation, to a ranking calculator 300c in the ranking manager 300. The ranking calculator 300c then calculates the social rank of the first user A based on the relation metrics of aggregated outgoing communication events from the first user in the cluster, as follows. The calculation is made in multiple successive iterations such that the social rank of the first user is calculated in each iteration based on the relation metrics of outgoing events, and further based on social ranks calculated in a preceding iteration in the same manner for other users in the cluster. The first calculation of social rank of the first user A is made by setting the ranks of all users in the cluster to a default value, e.g. 1.

These iterations are continued, using the social ranks obtained in the preceding iteration as input in each new iteration, until the social rank of the first user is deemed to be stabilized, i.e. it does not change significantly any more. Thus, in the first few iterations the social rank of the first user changes relatively much for each new iteration, while it changes more slowly in later iterations, also referred to as convergence. It may be decided that the social rank of the first user is deemed to be stabilized when it does not change more than a preset degree for each new iteration, e.g. less than 1%, when the resulting rank is deemed relevant and useful.

The resulting social rank of the first user and other users, as calculated by ranking calculator 300c, can then be provided as relevant ranking information to any party obliged to use this information for any purpose, e.g. to one or more service providers 310, as shown in the figure. For example, service providers 310 may create and offer customized and adapted services to the users based on the social ranks of the users. Various actions may also be taken to retain subscribers and/or to predict and avoid so-called “churn” behavior of the subscribers. The actions that can be made based on the calculated social ranks are however outside the scope of this invention.

The formula used by ranking calculator 300c in each iteration for calculating the social rank of the users may be configured in different ways, depending on the implementation. For example, the ranking calculator 300c may be further adapted to calculate the social rank “SR(A)” of the first user A in each iteration using any of the formulas:

$$\begin{matrix}SR ( A ) = ( 1 - d ) + d * \sum ( \frac{SR ( other )}{RM ( outgoing )} ) & ( 1 ) \\ and & \\ SR ( A ) = ( 1 - d ) + d * \sum ( SR ( other ) * RM ( outgoing ) ) & ( 2 )\end{matrix}$$

where “SR(other)” refers to social ranks calculated in a preceding iteration for the other users in the cluster, “RM(outgoing)” is the relation metrics of aggregated outgoing events from the first user to the other users, and “d” is a preset damping constant.

The ranking manager 400 and its functional components 300a-c may be configured and adapted to provide further optional features and embodiments. In some exemplifying embodiments, the relation metrics may refer to any of: indications of whether the users have communicated, aggregated session duration, number of sessions, and aggregated charged amount. The ranking calculator 300c may be further adapted to reduce the relation metrics by a weighting factor referring to any of: a social distance between the first user and the other users, whether the events are outgoing or incoming relative the first user, and a recency of the communication events from the first user to the other users.

In further exemplifying embodiments, the predefined minimum communication event threshold may refer to at least one of: a minimum session duration, a minimum number of sessions and a minimum charged amount. The data receiver 300a may be further adapted to obtain at least some of the collected data from CDRs referring to any of: session duration, number of sessions, charged amount. The data analyzer 300b may be further adapted to qualify the users for the cluster based on their degree of activity in the network. The data analyzer 300b may be further adapted to form a social graph with nodes representing the users in the cluster and edges between the nodes representing social relations between the users, and to form an event matrix with the relation metrics for the users in the cluster.

A first calculation example of determining the social rank of a first user A in the cluster and corresponding event matrix of FIGS. 4a and 4b, will now be described. In this example, formula (1) above is used in multiple iterations as follows. It is assumed that each communication event accounts for a metric value of 1 point. A specific weighting scheme is also used for determining relation metrics where the metric value of 1 point for a communication event from a first user to a second user is reduced by half to 0.5 points, if the first user also has performed an event with a third user, the second user thus sharing the relation to the first user with the third user. If a relation is not shared with another user, the metric value for the event is not reduced, thus retaining 1 point in the calculation.

From A's perspective, in this example of occurred events, A alone has made an event with B such that B gives full points to A. Further, A as well as B has made an event with C such that C gives only 0.5 points to A. From B's perspective, A as well as B has made an event with C such that C gives only 0.5 points to B. From C's perspective, C alone has made an event with A such that A gives full points to C. This weighting scheme is applied in the calculations below.

First iteration: SR(A)=SR(B)=SR(C)=1, where 1 is an initial default value of the social ranks of all users A-C.

SR(A)=0.5+0.5*(SR(B)+SR(C)/2)=1.25

SR(B)=0.5+0.5*(SR(C)/2)=0.75

SR(C)=0.5+0.5*(SR(A))=1

Second iteration: SR(A)=1.25, SR(B)=0.75 and SR(C)=1.00 according to the preceding iteration.

SR(A)=0.5+0.5*(0.75+½)=1.125

SR(B)=0.5+0.5*(½)=0.75

SR(C)=0.5+0.5*(1.25)=1.125

Third iteration: SR(A)=1.125, SR(B)=0.75 and SR(C)=1.125 according to the preceding iteration.

SR(A)=0.5+0.5*(0.75+1.125/2)=1.15625

SR(B)=0.5+0.5*(1.125/2)=0.78125

SR(C)=0.5+0.5*(1.125)=1.0625

. . . and so forth.

This iteration procedure is repeated a number of times until the social rank of the first user A is deemed to be stabilized, i.e. it does not change significantly any more, e.g. when it does not change more than a preset degree for each new iteration and the resulting rank is deemed relevant and useful. In the above example, after a number of iterations have been made, the resulting social ranks of users A, B and C are stabilized as:

### SR(A)=1.1538

### SR(B)=0.7692

### SR(C)=1.0769

It can thus be concluded that A has the highest rank followed by C and B, respectively, when using the formula (1) in the iterations.

A second calculation example of determining the social rank of a first user A in the cluster and corresponding event matrix of FIGS. 4a and 4b, will now be described. In this example, formula (2) above is used in multiple iterations as follows. The same assumptions as in the above first example are used here as well.

First iteration: SR(A)=SR(B)=SR(C)=1, as in the previous first example.

SR(A)=0.5+0.5*(SR(B)+SR(C)*2)=2

SR(B)=0.5+0.5*(SR(C)*2)=1.5

SR(C)=0.5+0.5*(SR(A))=1

Second iteration: SR(A)=2, SR(B)=1.5 and SR(C)=1 according to the preceding iteration.

SR(A)=0.5+0.5*(1.5+1*2)=2.25

SR(B)=0.5+0.5*(1*2)=1.5

SR(C)=0.5+0.5*(2)=1.5

. . . and so forth.

This iteration procedure is repeated a number of times until the social rank of the first user A is deemed to be stabilized and the resulting rank is deemed relevant and useful. In this second example, the resulting social ranks of users A, B and C are stabilized as:

### SR(A)=6

### SR(B)=4

### SR(C)=3.5

It can thus be concluded that A has the highest rank followed by B and C, respectively, when using the formula (2) in the iterations.

In the above first and second calculation examples, only outgoing communication events are considered. However, it is possible to also consider the duration of incoming communication events, e.g. by multiplying the duration of outgoing and incoming communication events by different weighting factors, e.g. 1 and 0.5, respectively.

It is also possible to also consider the recency of the events of interest by multiplying the metric values of the events by different weighting factors depending on the recency of each event. For example, if Y is defined as the number of days since the event and Y(max) is defined as the maximum number of days to consider before the event is deemed out-of-date, a weighting factor W may be defined as:

W=0 if Y>Y(max) (3)

W=1/Y if Y<Y(max) (4)

This weighting factor W is thus related to each specific event and is multiplied to the metric value of that event to produce a weighted event metric depending on the recency of the event.

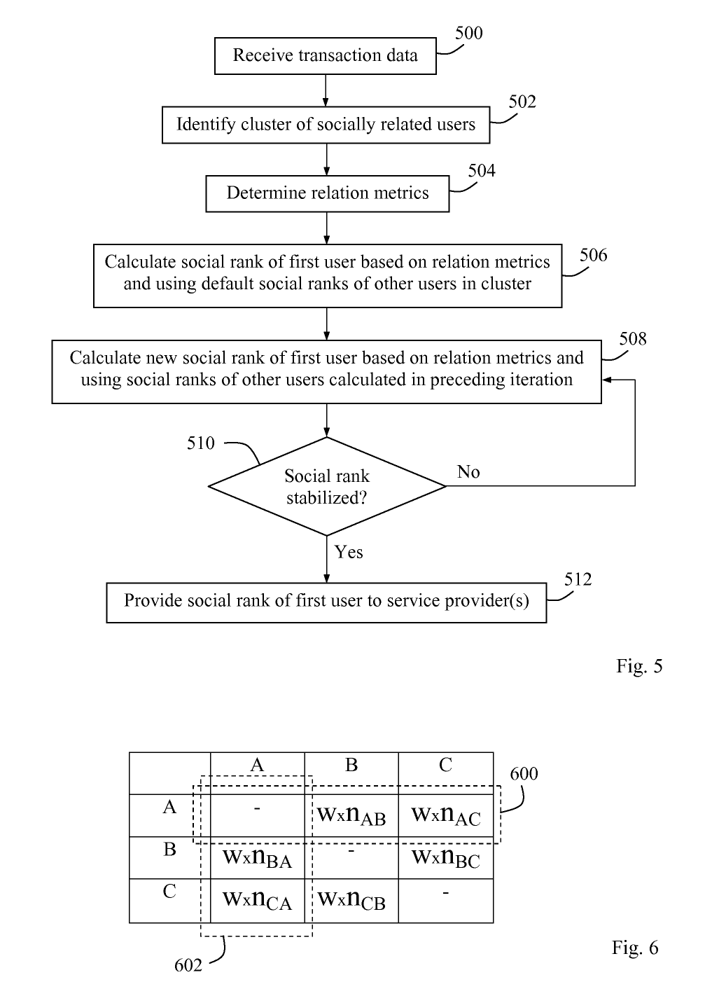

An example of how information can be provided on a social rank of a first user within a plurality of users in a telecommunication network, will now be described with reference to the flow chart in FIG. 5. The actions in this procedure may be preformed by a ranking manager such as the one described above for FIG. 3. In a first action 500, the ranking manager receives collected transaction data referring to communication events involving said users, which may be done on a continuous basis.

In a next action 502, the ranking manager identifies a cluster of socially related users, including the first user, from said plurality of users based on the collected transaction data, wherein any two users in the cluster are deemed to be socially related when exceeding a predefined minimum communication event threshold. In a further action 504, the ranking manager determines relation metrics for the users in the identified cluster based on the collected transaction data, where the relation metrics indicate an extent or degree of aggregated outgoing communication events between the users in the cluster. As mentioned above, also incoming events may be considered when determining the relation metrics, e.g. by applying different weighting factors for outgoing and incoming events.

The ranking manager will now, in the following actions, calculate the social rank of the first user in multiple successive iterations such that the social rank of the first user is calculated in each iteration based on relation metrics of aggregated outgoing communication events from the first user, and further based on social ranks calculated in a preceding iteration for other users in the cluster being subjected to the outgoing communication events, until the social rank of the first user is deemed to be stabilized, Thus, in a further action 506, the ranking manager calculates a social rank of the first user based on the determined relation metrics, and in the first iteration using default social ranks of the other users in the cluster, e.g. a default rank of 1 for all users. However, the solution is not limited to using any particular default rank value in this action.

In a next action 508, the ranking manager calculates a new social rank of the first user in the next iteration based on the relation metrics and using the social ranks of the other users calculated in the preceding iteration of action 506. It is then determined in an action 510 whether the social rank of the first user is deemed to be stabilized. If not, the procedure returns to action 508 for calculation of the social rank in a next iteration. At some point, the social rank of the first user is deemed to be stabilized in action 510, and in that case the ranking manager can provide the calculated social rank of the first user to one or more service providers, in a final action 512.

As mentioned above, various weighting factors may be applied to adjust the metric values of registered events in different ways, e.g. accounting for recency, social distance, direction (i.e. outgoing or incoming), type of communication, time of day, week or season when the event took place, and so forth.

FIG. 6 illustrates an event matrix in a general case involving three users A-C when a relation metric “n” for each mutual relation is adjusted by multiplying it with a weighting factor “w”, e.g. according to one or more of the above-described weighting schemes. The Regarding the first user A, the row 600 of weighted relation metrics refers to outgoing events from A to B and C, while the column 602 of weighted relation metrics refers to incoming events from B and C to A. Although the examples described above involve only three users A-C, it should be understood that the solution can be applied in an equivalent manner for any number of users in an identified cluster of socially related users.

While the invention has been described with reference to specific exemplary embodiments, the description is generally only intended to illustrate the inventive concept and should not be taken as limiting the scope of the invention. The invention is defined by the appended claims.

1. A method of providing information on a social rank of a first user (A) within a plurality of users (302) in a telecommunication network, the method comprising:
receiving collected transaction data referring to communication events involving said users,
identifying a cluster of socially related users, including the first user, from said plurality of users based on the collected transaction data, wherein any two users in the cluster are deemed to be socially related when exceeding a predefined minimum communication event threshold,
determining relation metrics for the users in the cluster based on the collected transaction data, said relation metrics indicating an extent of aggregated outgoing communication events between the users in the cluster,
calculating the social rank of the first user in multiple successive iterations such that the social rank of the first user is calculated in each iteration based on relation metrics of aggregated outgoing communication events from the first user, and further based on social ranks calculated in a preceding iteration for other users (B,C) in the cluster being subjected to said outgoing communication events, until the social rank of the first user is deemed to be stabilized, and
providing the calculated social rank of the first user to one or more service providers.

2. The method according to claim 1, wherein the social rank SR(A) of the first user is calculated in each iteration using any of the formulas:
$$SR ( A ) = ( 1 - d ) + d * \sum ( \frac{SR ( other )}{RM ( outgoing )} )$$
$$and$$
$$SR ( A ) = ( 1 - d ) + d * \sum ( SR ( other ) * RM ( outgoing ) )$$
where SR(other) is said social ranks calculated in a preceding iteration for said other users, RM(outgoing) is the relation metrics of aggregated outgoing communication events from the first user to said other users, and d is a preset damping constant.

3. The method according to claim 1, wherein said relation metrics refer to any of: indications of whether the users have communicated, aggregated session duration, number of sessions, and aggregated charged amount.

4. A method according to claim 1, wherein said relation metrics is reduced by a weighting factor referring to any of: a social distance between the first user and the other users, whether the events are outgoing or incoming relative the first user, and a recency of said communication events from the first user to the other users.

5. The method according to claim 1, wherein the predefined minimum communication event threshold refers to at least one of: a minimum session duration, a minimum number of sessions and a minimum charged amount.

6. The method according to claim 1, wherein at least some of the collected data is obtained from Call Detail Records (CDRs) and refers to any of: session duration, number of sessions, charged amount.

7. The method according to claim 1, wherein the users are qualified for said cluster based on their degree of activity in the network.

8. The method according to claim 1, further comprising forming a social graph with nodes representing the users in the cluster and edges between the nodes representing social relations between the users, and forming an event matrix with said relation metrics for the users in the cluster.

9. A ranking manager apparatus configured to provide information on a social rank of a first terminal user within a plurality of terminal users in a telecommunication network, comprising:
a data receiver adapted to receive collected transaction data referring to communication events involving said users,
a data analyzer adapted to identify a cluster of socially related users, including the first user, from said plurality of users based on the collected transaction data, wherein any two users in the cluster are deemed to be socially related when exceeding a predefined minimum communication event threshold, and further adapted to determine relation metrics for the users in the cluster based on the collected transaction data, said relation metrics indicating an extent of aggregated outgoing communication events between the users in the cluster, and
a ranking calculator adapted to calculate the social rank of the first user in multiple successive iterations by calculating the social rank of the first user in each iteration based on relation metrics of aggregated outgoing communication events from the first user, and further based on social ranks calculated in a preceding iteration for other users in the cluster being subjected to said outgoing communication events, until the social rank of the first user is deemed to be stabilized, and further adapted to provide the calculated social rank of the first user to one or more service providers.

10. The ranking manager apparatus according to claim 9, wherein the ranking calculator is further adapted to calculate the social rank SR(A) of the first user in each iteration using any of the formulas:
$$SR ( A ) = ( 1 - d ) + d * \sum ( \frac{SR ( other )}{RM ( outgoing )} )$$
$$and$$
$$SR ( A ) = ( 1 - d ) + d * \sum ( SR ( other ) * RM ( outgoing ) )$$
where SR(other) is said social ranks calculated in a preceding iteration for said other users, RM(outgoing) is the relation metrics of aggregated outgoing communication events from the first user to said other users, and d is a preset damping constant.

11. The ranking manager apparatus according to claim 9, wherein said relation metrics refer to any of: indications of whether the users have communicated, aggregated session duration, number of sessions, and aggregated charged amount.

12. The ranking manager apparatus according to claim 9, wherein the ranking calculator is further adapted to reduce said relation metrics by a weighting factor referring to any of: a social distance between the first user and the other users, whether the events are outgoing or incoming relative the first user, and a recency of said communication events from the first user to the other users.

13. The ranking manager apparatus according to claim 9, wherein the predefined minimum communication event threshold refers to at least one of: a minimum session duration, a minimum number of sessions and a minimum charged amount.

14. The ranking manager apparatus according to claim 9, wherein the data receiver is further adapted to obtain at least some of the collected data from Call Detail Records (CDRs) referring to any of: session duration, number of sessions, charged amount.

15. The ranking manager apparatus according to claim 9, wherein the data analyzer is further adapted to qualify the users for said cluster based on their degree of activity in the network.

16. The ranking manager apparatus according to claim 9, wherein the data analyzer is further adapted to form a social graph with nodes representing the users in the cluster and edges between the nodes representing social relations between the users, and to form an event matrix with said relation metrics for the users in the cluster.
